(19) United States
(12) Patent Application Publication
(10) Pub. No.: US 2017/0172355 A1
(43) Pub. Date: Jun. 22, 2017

(54) Leakproof flexible container for liquid soap

(71) Applicant: Po-Hui Lin, Taipei (TW)

(72) Inventor: Po-Hui Lin, Taipei (TW)

(21) Appl. No.: 15/448,610

(22) Filed: Mar. 3, 2017

(51) Int. Cl. A47K 5/12; B05B 11/00

(52) U.S. Cl. CPC A47K 5/1211; B05B 11/3045; B05B 11/0043

(57) ABSTRACT

A flexible container is mounted in a soap dispenser including a hand pump. The container includes a reservoir filled with liquid soap and including an opening; and a hollow leakproof device mounted on the opening and configured to communicate with the reservoir, the leakproof device including a releasable closure at an end, the closure having a suction face. The liquid soap is prevented from entering the leakproof device when the suction face is attached to the leakproof device in an inoperative position. The suction face is disengaged from the leakproof device by operating the hand pump to flow the liquid soap into the leakproof device via a gap between the suction face and the leakproof device.

### BACKGROUND OF THE INVENTION

1. Field of the Invention

The invention relates to flexible container and more particularly to a leakproof flexible soap container mounted in a soap dispenser.

2. Description of Related Art

Conventional flexible containers for liquid soap include a threaded cap for opening or closing the container. However, liquid (e.g., liquid soap) contained in the container may leak if the threaded fastening is not secured.

Thus, the need for improvement still exists.

### SUMMARY OF THE INVENTION

It is therefore one object of the invention to provide a flexible container mounted in a soap dispenser, comprising a reservoir filled with liquid soap and including an opening; a hollow leakproof device mounted on the opening and including a closure at an end, the closure having a suction face; wherein the liquid soap is prevented from entering the leakproof device when the suction face is attached to the leakproof device in an inoperative position; and wherein the suction face is disengaged from the leakproof device by operating the soap dispenser to flow the liquid soap into the leakproof device via a gap between the suction face and the leakproof device.

The above and other objects, features and advantages of the invention will become apparent from the following detailed description taken with the accompanying drawings.

### BRIEF DESCRIPTION OF THE DRAWINGS

FIG. 1 is a perspective view of a flexible container for liquid soap according to the invention;

FIG. 2 is an exploded perspective view of FIG. 1;

FIG. 3 is an exploded view of the leakproof device;

FIG. 4 is a side view in part section showing a soap dispensing operation by pressing a hand pump of a soap dispenser by mounting the container in the soap dispenser; and

FIG. 5 is a view similar to FIG. 4 showing an inoperative position of the soap dispenser.

### DETAILED DESCRIPTION OF THE INVENTION

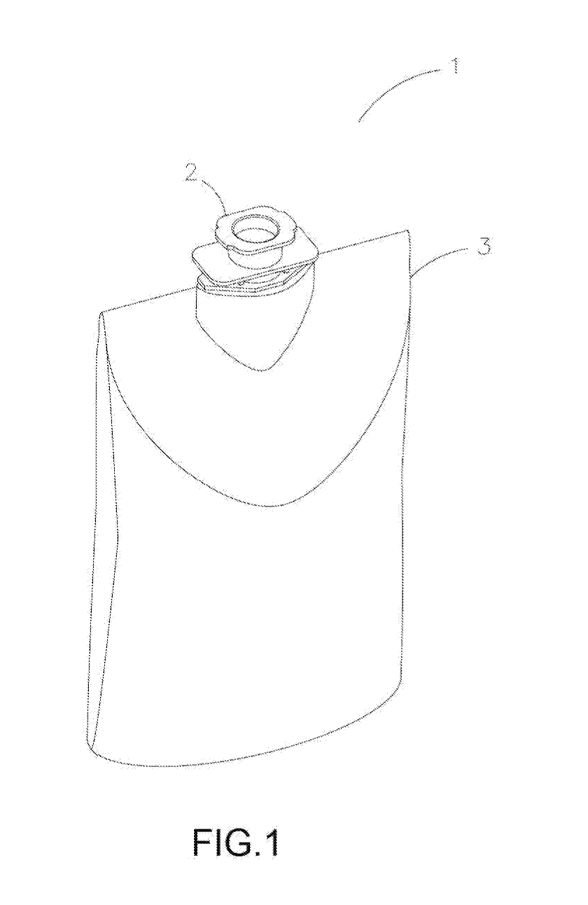

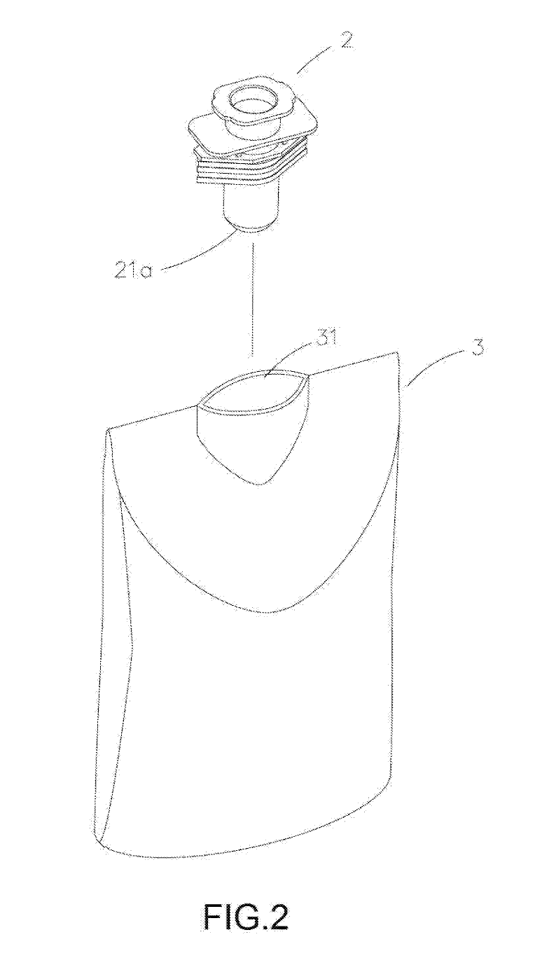

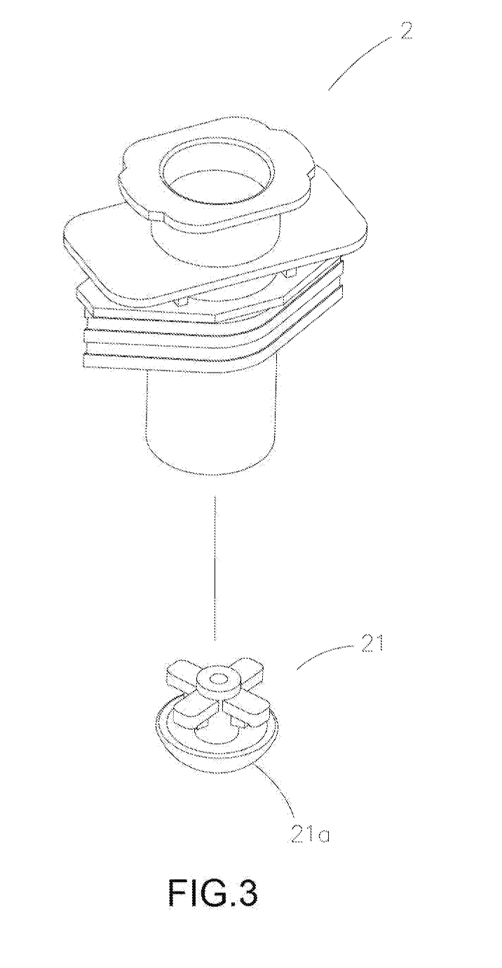

Referring to FIGS. 1 to 5, a flexible container 1 in accordance with the invention comprises the following components as discussed in detail below.

A leakproof device 2 is hollow and mounted on an opening 31 of a reservoir 3 which is filled with liquid soap 5. The leakproof device 2 includes a closure 21 at one end, the closure 21 having an exposed suction face 21a made of rubber. The other end of the leakproof device 2 is secured to a hand pump 41 of a soap dispenser 4 which houses both the leakproof device 2 and the reservoir 3.

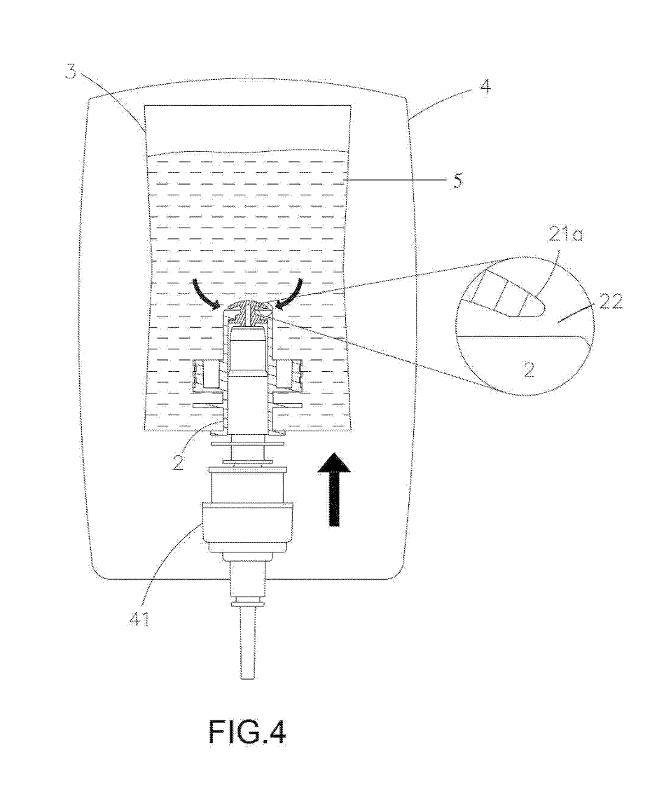

In a soap dispensing operation as shown in FIG. 4, a user may press the hand pump 41 to disengage the suction face 21 from the leakproof device 2. And in turn, liquid soap 5 flows into the leakproof device 2 via a gap 22 between the suction face 21 and the leakproof device 2. Finally, the liquid soap 5 flows out of the hand pump 41 for use.

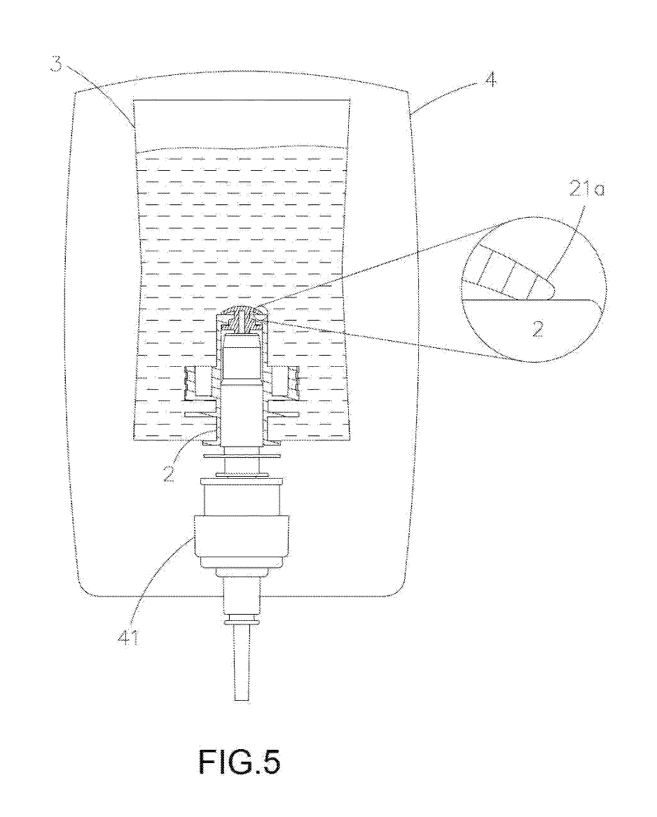

In an inoperative position as shown in FIG. 5, the suction face 21 is not activated by the hand pump 41. And in turn, the suction face 21 returns to it original position of attaching to the leakproof device 2. Thus, the liquid soap 5 is prevented from entering the leakproof device 2. The problem of leaking soap in an inoperative state is solved.

While the invention has been described in terms of preferred embodiments, those skilled in the art will recognize that the invention can be practiced with modifications within the spirit and scope of the appended claims.

What is claimed is:

1. A flexible container mounted in a soap dispenser including a hand pump, comprising:
a reservoir filled with liquid soap and including an opening; and
a hollow leakproof device mounted on the opening and configured to communicate with the reservoir, the leakproof device including a releasable closure at an end, the closure having a suction face;
wherein the liquid soap is prevented from entering the leakproof device when the suction face is attached to the leakproof device in an inoperative position; and
wherein the suction face is disengaged from the leakproof device by operating the hand pump to flow the liquid soap into the leakproof device via a gap between the suction face and the leakproof device.
